(19) United States
(12) Patent Application Publication
(10) Pub. No.: US 2010/0055257 A1
(43) Pub. Date: Mar. 4, 2010

(54) Chocolate candy

(76) Inventor: Dana Petersen Hervig, Apple Valley, MN (US)

Correspondence Address: DANA P. HERVIG, APT# 108, 4120 LEXINGTON AVE. S., EAGAN, MN, 55123, US

(21) Appl. No.: 12/231,134

(22) Filed: Aug. 31, 2008

(51) Int. Cl. A23G 3/54

(52) U.S. Cl. 426/103

(57) ABSTRACT

A filled candy with molded first and second outer chocolate shells. The first chocolate shell contains any of numerous selected fillings, for example, raw honey, a liqueur, or a blend of raw honey and other ingredients such as chocolate powder or nut butter. Before adding the filling, the chocolate shells are allowed to cool so that the filling will not be nutritionally altered by hot temperature from the shells. The filling is poured or injected into the first chocolate shell and is covered by the second shell of chocolate. The chocolate shells are either externally melted together or held together by an outer coating of melted chocolate. The assembly and fastening together of the first and second chocolate shells is therefore accomplished without transferring hot temperatures that would alter the beneficial nutritional qualities or textures of the fillings.

### BACKGROUND OF THE INVENTION

1. Technical Field

This invention relates to manufacturing a chocolate candy shell that preferably contains a liquid such as a liqueur or a gel such as raw honey. It would be desirable to have heat sensitive food products such as raw honey injected into precooled chocolate shells at temperatures below 100 degrees F. to preserve their natural qualities. Conventional methods of manufacturing chocolates can destroy the valuable enzyme content in raw honey by heating it over 100 degrees F.

Conventional chocolate candies such as a Pearson's Nut Goodie™ or a Snickers™ have a solid filling that is covered by melted chocolate. The filling is heated by the melted chocolate without issue since the sugar filling used does not have delicate nutrients or heat sensitivity as those used by the present invention does. Similarly, chocolate balls as by Lindt™ and chocolate Easter eggs have fillings with chocolate shell halves that are sealed together, however they are heated all the way through with adversely high temperatures instead of being filled and sealed after the shells are cool as shown by the present invention.

The present invention describes a method of injecting a filling of raw honey or other edible food product into a chocolate candy shell without heating them over 100 degrees F. and describes methods to seal the opening in the chocolate shell without adding significant heat to the filling. The present invention provides the automated low temperature injection of products into chocolate and sealed containment inside the chocolate for easy handling and distribution.

### SUMMARY OF THE INVENTION

The present invention uses melted chocolate that is formed into a first container shell that is allowed to cool before a liqueur, raw honey, or other combinations of filling ingredients are added. After the honey or other filling is added, a second piece of chocolate is connected with the first shell and heat is applied outside the candy to an adjoining seam line where the first and second pieces of chocolate come together. The heat applied has the effect of welding the outer two shell pieces of chocolate together along the seam line while the internal contents stay relatively cool. Thus, the candy is assembled with minimal conduction of heat to destroy the natural enzymes of the raw honey and or the natural textures and qualities of other fillings contained inside the chocolate. Raw honey is defined as honey that has not been processed or heated above 100 degrees F. Raw honey used with chocolate is a more alkalizing and healthful sweetener for diabetics.

Several alternatives are possible to contain the raw honey or other filling from spilling or contamination. For instance, instead of melting two chocolate shells together with a filing inside, a cool liquid chocolate or other candy coating that would harden could be poured on the filling to contain it in the first chocolate shell. Another method would be to pour a melted chocolate over the combined first and second chocolate shells wherein the first and second chocolate shells would not need to be melted together. While other heat sensitive containment alternatives for candy making may become obvious, it is the intent of the present invention to introduce a chocolate candy that contains raw honey and or liqueurs, as a more healthy or diverse alternative than is what is currently available.

### BRIEF DESCRIPTION OF THE DRAWINGS

The invention will be better understood, and objects other than those set forth above will become apparent when consideration is given to the following detailed description thereof. Such description makes reference to the drawings wherein:

FIG. 1 is an isometric view of a chocolate candy.

FIG. 2 is a side view of a chocolate candy.

FIG. 3 is an exploded cross section view of a chocolate candy.

FIG. 4 is an exploded isometric view of a chocolate candy.

FIG. 5 is a cross section view of a chocolate candy.

FIG. 6 is a cross section view of a chocolate candy.

FIG. 7 is a cross section view of a chocolate candy.

FIG. 8 is a cross section view of a chocolate candy.

### DETAILED DESCRIPTION OF THE INVENTION

The preferred embodiment of the invention will be described in detail with reference to the drawings, wherein like reference numerals represent like parts and assemblies throughout the several views. Reference to the preferred embodiment does not limit the scope of the invention, which is limited only by the scope of the claims attached hereto.

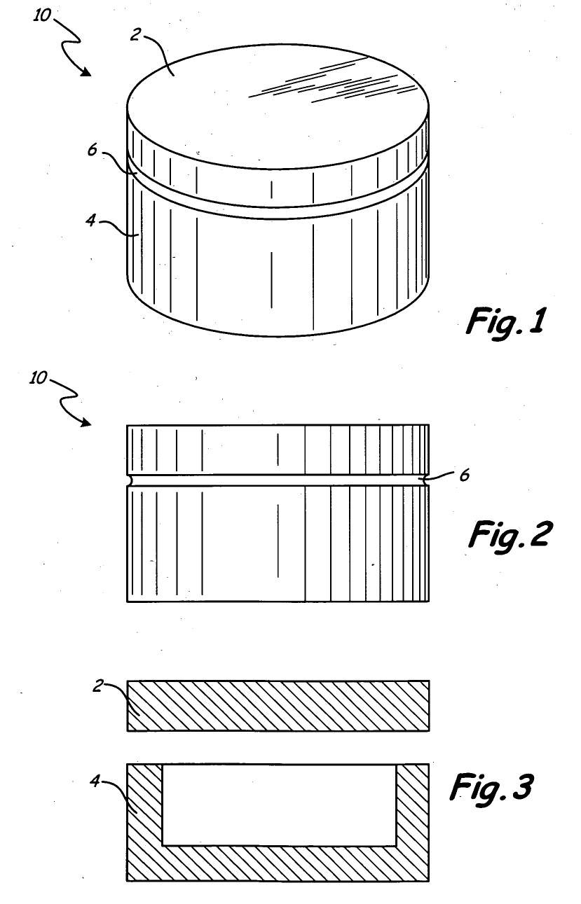

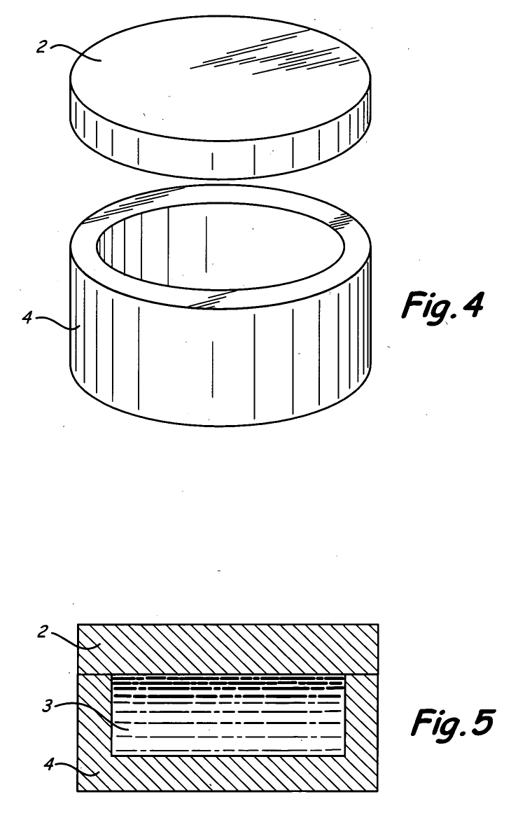

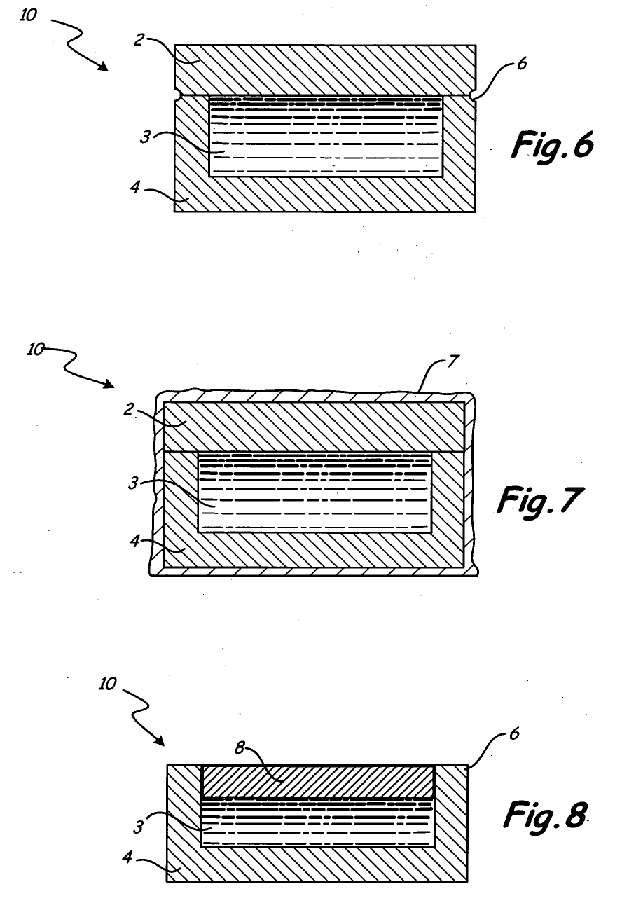

Referring now to FIGS. 1-8, the reference numeral 10, generally designates an embodiment of a chocolate candy. The chocolate candy 10 includes a first chocolate shell 4 that is injection molded into a cup shape and allowed to cool from over 140 degrees to below 90 degrees F. A liqueur, raw honey or other food filling 3 or preferably a blend of chocolate powder and raw honey 3 can be blended and poured or injected into the receptacle or cavity inside shell 4. Filling 3 could also be comprised of honey and nuts or other food ingredients not mentioned here. A second piece of chocolate 2 is injection molded into a shape that will cover first container shell 4 and is also allowed to cool below 90 deg. before contacting filling 3. Both first and second chocolate pieces mentioned are fitted together on an assembly line. Second chocolate 2 is fitted to first chocolate 4 and a seam line where chocolate 2 and chocolate 4 come together is melted together as shown by melted area 6 in FIGS. 1, 2 and 6. The melting or thermal sealing is performed only to the external sides of the shells 2 and 4. The melted area 6 joins the shells with the effect of welding first chocolate 4 and second chocolate 2 together. The process of melting the outside of chocolate 2 and chocolate 4 together reduces the transfer of heat into filling 3. Shells 2 and 4 can be made of white chocolate, dark chocolate or other candy or food substance. While shapes of candy 10 other than shown may be manufactured, the generally cylindrical shape of the assembled candy 10 shown in FIGS. 1 and 6, offers advantages in ease of manufacturing by allowing the passage of the-candy through an assembly tube that aligns shells 2 and 4 above and below each other into stacks and uses either blown hot air or two extendable and retractable semi-circular heating elements each of which extend 180 degrees around candy 10 to melt area 6 as the candies pass through the machine.

Alternatively as shown by FIG. 7, second chocolate 2 is fitted to first chocolate 4 and an outer coating of liquid chocolate 7 is applied to first and second pieces to hold them together. Coating 7 can be of chocolate that is melted at a temperature of over 100 degrees provided that first chocolate 4 and second chocolate 2 do not melt or deform or allow a temperature increase that would adversely alter the ingredients inside. FIG. 7 shows melted coating 7 surrounding the whole chocolate shown by FIGS. 3, 4 and 5. The important part of the food coating 7 is sealing chocolate 2 and chocolate 4 together as an alternative to melting the seam line shown by area 6 in FIG. 6. As an alternative to fully covering the chocolate as in FIG. 7, coating 7 could be drizzled or poured on chocolate 2 and need only partially cover the sides of chocolate 4 instead of the bottom as shown. The outer coating 7 is a melted chocolate substance that becomes solid at room temperature after the candy is assembled. The use of similar diameter cylindrically shaped molded surfaces of shells 2 and 4 allows a fixture to align shells 2 and 4 before coating 7 is poured over candy 10. A ring shaped ridge (not shown) may also be molded on the underside of shell 2 so that shell 2 would self center over shell 4 when placed on it as a method to ease alignment of shells 2 and 4 together when manufacturing. It may be desirable to substitute other melted candy flavors such as almond bark or strawberry instead of chocolate as the outer coating 7. Alternatively, when outer coating 7 is used, either or both of candy shells 2 and 4 may be molded and baked from a cookie batter made of wheat flour, sugar and fat. Coating 7 is made of primarily sugar, oil or milk fat and artificial or natural flavorings. Alternatively, coating 7 could be a non-nutritive food coating as is commonly used in candy making or could be a sealant coating as is commonly used to coat to coat breakfast cereals. Chocolate shells 2 and 4 are made of chocolate, evaporated sugar cane juice, cocoa butter, milk fat, vanilla and soy lecithin.

As a second alternative, a cool liquid chocolate 8 or other candy coating 8 as is commonly used in candy making could be poured or sprayed onto filling 3 provided that it would harden to seal and preserve the filling as shown in FIG. 8. The fully assembled chocolate 10 can be inserted in conventional paper or plastic packaging for distribution.

While the invention has been described in conjunction with specific embodiments thereof, it is evident that different alternatives, modifications, variations, and uses will be apparent to those skilled in the art in view of the foregoing description. Accordingly, the invention is not limited to these embodiments or the use of elements having specific configurations and shapes as presented herein.

I claim:

1. A candy comprising;
(a) a molded first candy shell having a receptacle;
(b) a molded second candy shell;
(c) a filling;
(d) fastening means between said first and second candy shells, wherein, after the shells have substantially cooled and hardened from being molded, said filling is contained in said receptacle between the shells by sealing of a seam line between the shells.

2. The candy according to claim 1, wherein the first and second candy shells are made with chocolate.

3. The candy according to claim 1, wherein the filling contains raw honey.

4. The candy according to claim 1, wherein the filling contains a liqueur.

5. The candy according to claim 1, wherein the first and second shells join to form a generally cylindrical shape.

6. The candy according to claim 1, wherein said fastening means is a melted connection between said first and second candy shells.

7. The candy according to claim 1, wherein said fastening means is a food coating over the seam line between said first and second candy shells.

8. The chocolate according to claim 7, wherein said food coating is a melted liquid that becomes solid at room temperature.

9. The chocolate according to claim 7, wherein said food coating contains chocolate.

10. The candy according to claim 1, wherein said first candy shell is molded from a cookie dough.

11. The candy according to claim 1, wherein said second candy shell is molded from a cookie dough.

12. A candy comprising;
(a) a molded shell having a receptacle with an opening;
(b) a filling;
(c) a coating, wherein said filling is contained in said receptacle by covering the filling and said opening of the receptacle with said coating.

13. The candy according to claim 12, wherein the coating is made with chocolate.

14. The candy according to claim 12, wherein the filling is raw honey.

15. The candy according to claim 12, wherein said molded shell is made with chocolate.

16. The candy according to claim 12, wherein said molded shell is made with cookie dough.
